(19) United States
(12) Patent Application Publication
(10) Pub. No.: US 2025/0137803 A1
(43) Pub. Date: May 1, 2025

(54) APPARATUS AND METHOD FOR CALCULATING AN ESTIMATED TIME OF ARRIVAL CONSIDERING SIGNAL WAITING TIME

(71) Applicants: HYUNDAI MOTOR COMPANY, Seoul (KR); KIA CORPORATION, Seoul (KR)

(72) Inventor: Soo Yeon Shin, Seoul (KR)

(73) Assignees: HYUNDAI MOTOR COMPANY, Seoul (KR); KIA CORPORATION, Seoul (KR)

(21) Appl. No.: 18/612,833

(22) Filed: Mar. 21, 2024

(30) Foreign Application Priority Data
Oct. 25, 2023 (KR) 10-2023-0143621

(51) Int. Cl. G01C 21/36

(52) U.S. Cl. CPC G01C 21/3691; G01C 21/3697

(57) ABSTRACT

An apparatus and method are provided for calculating estimated arrival time. The apparatus includes a route setting unit configured to set a route for a destination of a user vehicle. The apparatus also includes a vehicle location determining unit configured to determine a location of the user vehicle and identify a traffic signal to be encountered on the route based on the location of the user vehicle. The apparatus further includes a traffic light waiting time prediction unit configured to calculate in real time a traffic light waiting time expected after the user vehicle enters a waiting queue of the traffic signal based on signal change 10 data for the traffic signal and vehicle movement data of vehicles in the waiting queue. The apparatus further includes an estimated arrival time calculating unit configured to calculate an estimated arrival time to the destination based on the traffic light waiting time.

### CROSS-REFERENCE TO RELATED APPLICATION

This application claims priority to and the benefit of Korean Patent Application No. 10-2023-0143621, filed in the Korean Intellectual Property Office on Oct. 25, 2023, the entire contents of which are incorporated herein by reference.

### TECHNICAL FIELD

The present disclosure relates to an apparatus and method for calculating an estimated arrival time considering traffic light waiting time.

### BACKGROUND

Navigation is a system that provides guidance to a destination by providing optimal route guidance to a driver of a vehicle. Navigation provides various route search options, such as minimum time and shortest distance to the user's desired destination and guides the user to the desired route.

When there is severe congestion at traffic lights, such as in a bottleneck situation or at an intersection with very short left/right-turn lights, there are frequent cases of waiting in a queue lane for a long time (e.g., several signal cycles) before passing the signal light and then entering the normal lane. In this case, the estimated time of arrival (ETA) (hereinafter also referred to as estimated arrival time) gradually increases by the minute due to unexpected waiting at the traffic light. If a driver fails to enter the lane in advance, e.g., without recognizing the long queue, situations such as accidents due to excessive cutting in, imposed fines, and increased arrival times due to unintentional detours may occur. On the other hand, in some cases in which a driver has waited in the traffic light queue, there may be situations where such waiting in the queue was unnecessary because the lane turned out to be an adjacent lane instead of the actual lane on the route of the vehicle.

Existing navigation systems do not provide detailed information on queuing conditions at a traffic light (e.g., queuing information on each lane, etc.).

### SUMMARY

Embodiments of the present disclosure provide an apparatus and method for calculating an estimated arrival time considering traffic light waiting time. By predicting estimated traffic light waiting time on a route of a vehicle by utilizing information on traffic signal and vehicle movement uploaded in real-time, the apparatus and method may enable users to recognize a waiting queue. Further, the apparatus and method may calculate a destination arrival time more accurately based on the estimated traffic light waiting time on the route of the vehicle. The apparatus and method may thus reduce unnecessary waiting and/or minimize user inconvenience.

In an embodiment, an apparatus is provided for calculating an estimated

arrival time considering traffic light waiting time. The apparatus includes a route setting unit configured to set a route for a destination of a user vehicle input by a user through a navigation system. The apparatus also includes a vehicle location determining unit configured to determine a location of the user vehicle on the route by using global navigation satellite system (GNSS) data. The vehicle location determining unit is also configured to identify a traffic signal to be encountered by the user vehicle on the route based on the location of the user vehicle. The apparatus additionally includes a traffic light waiting time prediction unit configured to calculate in real time a traffic light waiting time expected after the user vehicle enters a waiting queue of the traffic signal based on signal change data for the traffic signal and vehicle movement data of vehicles in the waiting queue of the traffic signal. The apparatus further includes an estimated arrival time calculating unit configured to calculate an estimated arrival time to the destination based on the traffic light waiting time.

The vehicle location determining unit may be configured to determine the location of the user vehicle on a lane-by-lane basis using precise positioning and map matching based on the GNSS data.

The vehicle location determining unit may be configured to identify the traffic signal to be encountered by the user vehicle, from among traffic signals on the route, using one or both of image recognition or data obtained from a traffic signal data server.

The traffic light waiting time prediction unit may be configured to collect the vehicle movement data of vehicles having encountered the traffic signal using data obtained from a vehicle location data server to which information on locations of vehicles on the route is uploaded in real time.

The traffic light waiting time prediction unit may be configured to collect the signal change data for the traffic signal from a traffic signal data server.

The traffic light waiting time prediction unit may be configured to, when an entry of the user vehicle into the waiting queue of the traffic signal is detected based on the location of the user vehicle, provide a notification about the traffic light waiting time calculated in real time to the user.

The traffic light waiting time prediction unit may be configured to detect the entry of the user vehicle into the waiting queue of the traffic signal based on whether the user vehicle has entered a particular lane designated as the waiting queue.

The traffic light waiting time prediction unit may be configured to predict the traffic light waiting time based on a signal change period of the traffic signal and an average movement distance of the vehicles in the waiting queue during the signal change period.

The estimated arrival time calculating unit may be configured to, when the calculated traffic light waiting time is greater than a reference traffic light waiting time by more than a preset criterion, determine that a delay time has occurred in the waiting queue. The estimated arrival time calculating unit may also be configured to calculate the estimated arrival time to the destination by reflecting the delay time.

The estimated arrival time calculating unit may be configured to update an existing estimated arrival time to destination by using the calculated estimated arrival time to destination. The estimated arrival time calculating unit may also be configured to provide information on the waiting queue and the delay time occurring in the waiting queue to the user through the navigation system.

In another embodiment, a method is provided for calculating an estimated arrival time considering traffic light waiting time. The method includes setting a route for a destination of a user vehicle input by a user through a navigation system. The method also includes determining a location of the user vehicle on the route using global navigation satellite system (GNSS) data. The method additionally includes identifying a traffic signal to be encountered by the user vehicle on the route based on the location of the user vehicle. The method further includes calculating in real time a traffic light waiting time expected when the user vehicle enters a waiting queue of the traffic signal based on signal change data for the traffic signal and vehicle movement data of vehicles having encountered the traffic signal. The method further still includes calculating an estimated arrival time to the destination of the user vehicle based on the traffic light waiting time.

Determining the location of the user vehicle may include determining the location of the user vehicle on a lane-by-lane basis using precise positioning and map matching based on the GNSS data.

Identifying the traffic signal to be encountered by the user vehicle may include identifying the traffic signal, from among traffic signals on the route, using one or both of image recognition or data obtained from a traffic signal data server.

Calculating the expected traffic light waiting time in real time may include collecting vehicle movement data of vehicles having encountered the traffic signal using data obtained from a vehicle location data server to which information on locations of vehicles on the route is uploaded in real time.

Calculating the expected traffic light waiting time in real time may include collecting the signal change data for the traffic signal from a traffic signal data server.

The method may further include providing a notification about the traffic light waiting time calculated in real time to the user when an entry of the user vehicle into the waiting queue of the traffic signal is detected based on the location of the user vehicle.

Calculating the traffic light waiting time in real time may further include detecting the entry of the user vehicle into the waiting queue of the traffic signal based on detecting an entry of the user vehicle into a particular lane including the waiting queue.

Calculating the expected traffic light waiting time in real time may include predicting the traffic light waiting time based on a signal change period of the traffic signal and an average movement distance of the vehicles in the waiting queue during the signal change period.

Calculating the estimated arrival time to the destination of the user vehicle may include determining, when the calculated traffic light waiting time is greater than a reference traffic light waiting time by a preset criterion or more, that a delay time has occurred in the waiting queue. Calculating the estimated arrival time to the destination of the user vehicle may further include calculating the estimated arrival time to destination by reflecting the delay time.

Calculating the estimated arrival time to the destination of the user vehicle may further include updating an existing estimated arrival time to the destination by using the calculated the estimated arrival time to destination. The method may further include visually and/or audibly providing information on the waiting queue and the delay time occurring in the waiting queue to the user through the navigation system.

An apparatus and method for calculating an estimated arrival time considering traffic light waiting time according to embodiments of the present disclosure may, by predicting estimated traffic light waiting time on a route of a vehicle by utilizing information on traffic signal and vehicle movement uploaded in real-time, enable a user to recognize a waiting queue. The apparatus and method may also calculate a destination arrival time more accurately based on the estimated traffic light waiting time on the route of the vehicle. The apparatus and method may thus reduce unnecessary waiting and/or minimize user inconvenience.

### BRIEF DESCRIPTION OF THE DRAWINGS

FIG. 1 schematically shows a system for calculating an estimated arrival time considering traffic light waiting time, according to an embodiment.

FIG. 2 is a block diagram of an apparatus for calculating an estimated arrival time considering traffic light waiting time, according to an embodiment.

FIG. 3 illustrates a situation in which an apparatus for calculating an estimated arrival time considering traffic light waiting time provides an alarm for a traffic light waiting time and an estimated arrival time to a user, according to an embodiment.

FIG. 4 is a flowchart of a method for calculating an estimated arrival time considering traffic light waiting time, according to an embodiment.

FIG. 5 is a flowchart of a method for calculating an estimated arrival time considering traffic light waiting time, according to another embodiment.

FIG. 6 is a flowchart of a method for calculating an estimated arrival time considering traffic light waiting time, according to yet another embodiment.

FIG. 7 is a block diagram of a computing device, according to an embodiment.

### DETAILED DESCRIPTION

Embodiments of the present disclosure are described more fully hereinafter with reference to the accompanying drawings in order to enable a person having ordinary skill in the art to readily implement the disclosed embodiments. As those having ordinary skill in the art should realize, the described embodiments may be modified in various different ways without departing from the spirit or scope of the present disclosure. In order to clarify the present disclosure, parts that are not related to the description have been omitted. Also, the same elements or equivalents are referred to with the same reference numerals throughout the specification.

Unless explicitly described to the contrary, the word “comprise” and variations such as “comprises” or “comprising” should be understood to imply the inclusion of stated elements but not the exclusion of any other elements. The same is intended for words such as “have” and “include” and variations. Terms including an ordinary number, such as first and second, are used for describing various constituent elements, but the constituent elements are not limited by the terms. The terms are only used to differentiate one component from other components.

The terms “unit”, “part” or “portion”, “-er”, and “module” in the specification refer to a unit that processes at least one function or operation, which may be implemented by hardware, software, or a combination of hardware and software. When a unit, part, module, component, device, element, or the like of the present disclosure is described as having a purpose or performing an operation, function, or the like, the unit, part, module, component, device, or element should be considered herein as being “configured to” meet that purpose or to perform that operation or function.

Hereinafter, embodiments of the present disclosure are described with reference to the drawings.

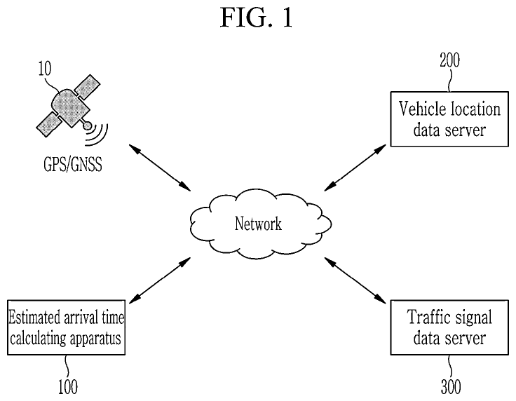

FIG. 1 schematically shows a system for calculating an estimated arrival time considering traffic light waiting time, according to an embodiment.

Referring to FIG. 1, a system for calculating an estimated arrival time considering traffic light waiting time may include a global positioning system (GPS)/global navigation satellite system (GNSS) 10, an apparatus 100 for calculating an estimated arrival time considering traffic light waiting time (sometimes referred to herein as an estimated arrival time calculating apparatus 100), a vehicle location data server 200, and a traffic signal data server 300.

The GPS/GNSS 10 is a global positioning information service system that provides precise positioning information to anyone, anywhere, at any time by using radio waves transmitted from satellites. The GPS/GNSS 10 may provide positioning information about a user vehicle and other vehicles to the vehicle location data server 200 and/or the estimated arrival time calculating apparatus 100 through a network.

The estimated arrival time calculating apparatus 100 is configured to, by utilizing information on a traffic signal and vehicle movement uploaded in real-time, predict a traffic light waiting time of a traffic signal on a route of the user vehicle, The estimated arrival time calculating apparatus 100 may also be configured to calculate an estimated arrival time to a destination of the user vehicle considering the predicted traffic light waiting time.

The vehicle location data server 200 may provide location and movement information of the vehicle to the estimated arrival time calculating apparatus 100. The vehicle location data server 200 may provide movement information on not only the user vehicle but also on other vehicles on the route of the user vehicle. The vehicle location data server 200 may collect and store location data of the vehicles in real time from the GPS/GNSS 10.

The traffic signal data server 300 may provide information on the traffic signal to the estimated arrival time calculating apparatus 100. The traffic signal data server 300 may provide signal change data of the traffic signals on the route of the user vehicle. The traffic signal data server 300 may be an intelligent transport systems (ITS) server, for example.

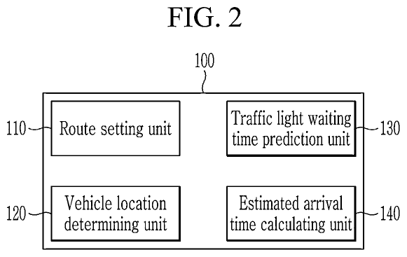

FIG. 2 is a block diagram of an apparatus for calculating an estimated arrival time considering traffic light waiting time, according to an embodiment.

Referring to FIG. 2, the estimated arrival time calculating apparatus 100 may include a route setting unit 110, a vehicle location determining unit 120, a traffic light waiting time prediction unit 130 and an estimated arrival time calculating unit 140.

The route setting unit 110 may set a route to a destination input by the user through a navigation system. The route setting unit 110 may provide information on the route to the vehicle location determining unit 120.

The vehicle location determining unit 120 may determine a location of the user vehicle travelling the route by using GNSS. The vehicle location determining unit 120 may identify a traffic signal to be encountered on the route based on the location of the user vehicle.

The vehicle location determining unit 120 may determine a location of the user vehicle on a lane-by-lane basis through precise positioning and map matching based on GNSS data. In an example, the vehicle location determining unit 120 may determine the location with the accuracy of about 30 centimeters (cm) based on an open area by utilizing precise positioning, map matching, and GNSS correction information. The vehicle location determining unit 120 may update data including the determined vehicle location, speed, and/or the like in real time.

The vehicle location determining unit 120 may identify the traffic signal to be encountered by the user vehicle, from among traffic signals on the route of the user vehicle, through image recognition and/or data obtained from a traffic signal data server (e.g., the traffic signal data server 300 of FIG. 1). For example, the vehicle location determining unit 120 may know an exact location of the traffic signal that appears in front of the user vehicle, and the change state of the traffic signal, based on image recognition of the vehicle and/or traffic signal data received from an ITS server.

The traffic light waiting time prediction unit 130 may calculate in real time the traffic light waiting time expected after the user vehicle enters a waiting queue of the traffic signal based on the signal change data for the traffic signal and vehicle movement data of vehicles in the waiting queue of the traffic signal.

The traffic light waiting time prediction unit 130 may collect the vehicle location and movement data of vehicles having encountered the traffic signal from a vehicle location data server (e.g., the vehicle location data server 200 of FIG. 1) to which information on the locations of the vehicles on the route may be uploaded in real time.

The traffic light waiting time prediction unit 130 may collect the signal change data of the traffic signal from a traffic signal data server (e.g., the traffic signal data server 300 of FIG. 1). For example, the traffic light waiting time prediction unit 130 may collect data about the traffic signal from an ITS server in real time.

The traffic light waiting time prediction unit 130 may detect an entry of the user vehicle into the waiting queue of the traffic signal based on whether the user vehicle has entered a particular lane designated as the waiting queue. The vehicle location determining unit 120 may know whether the waiting queue (traffic light waiting lane) has been entered based on the location and route of the vehicle on a lane-by-lane basis and destination information.

The traffic light waiting time prediction unit 130 may predict the traffic light waiting time based on a signal change period of the traffic signal and an average movement distance of the vehicles in the waiting queue during the signal change period.

The traffic light waiting time prediction unit 130 may, when the entry of the user vehicle into the waiting queue of the traffic signal is detected based on the location of the user vehicle, provide notification about the traffic light waiting time, calculated in real time, to the user.

The estimated arrival time calculating unit 140 may calculate an estimated arrival time to the destination of the user vehicle based on the traffic light waiting time.

The estimated arrival time calculating unit 140 may, when the calculated traffic light waiting time is greater than a reference traffic light waiting time by a preset criterion or more, determine that a delay time has occurred in the waiting queue. The estimated arrival time calculating unit 140 may then calculate the estimated arrival time to the destination by reflecting the delay time.

The estimated arrival time calculating unit 140 may update the existing estimated arrival time to the destination based on the calculated estimated arrival time to the destination. The estimated arrival time calculating unit 140 may provide information on the delay time occurring in the waiting queue and the waiting queue to the user through the navigation system.

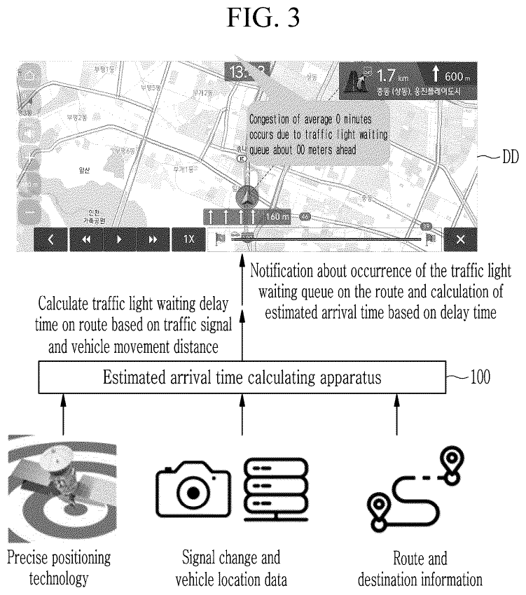

FIG. 3 illustrates a situation in which an apparatus for calculating an estimated arrival time considering traffic light waiting time provides an alarm of a traffic light waiting time and an estimated arrival time to a user, according to an embodiment.

Referring to FIG. 3, the estimated arrival time calculating apparatus 100 may calculate the estimated arrival time by using precise positioning technology, signal change and vehicle location data, and route and destination information. The signal change and vehicle location data may be obtained from the traffic signal data server 300 and the vehicle location data server 200, respectively. The route and destination information may be obtained through the GPS/the GNSS 10.

The estimated arrival time calculating apparatus 100 may calculate a traffic light waiting delay time on the route based on the traffic light and vehicle movement distance. The estimated arrival time calculating apparatus 100 may provide a notification about occurrence of the traffic light waiting queue on the route to the user. The estimated arrival time calculating apparatus 100 may calculate the estimated arrival time based on the delay time and may provide a notification of the calculated estimated arrival time to the user.

The estimated arrival time calculating apparatus 100 may provide the notification about occurrence of the traffic light waiting queue to the user through a display DD, such as a head-up display (HUD) or a cluster in the vehicle. The estimated arrival time calculating apparatus 100 may, when the user vehicle is within a predetermined distance from the waiting queue, calculate the delay time according to the traffic light waiting time of the waiting queue. The estimated arrival time calculating apparatus 100 may notify the user of the delay time through the display DD.

In an example, the estimated arrival time calculating apparatus 100 may, when there is about 200 meters left to the waiting queue of the traffic signal into which the user vehicle will enter, display the delay time of average 10 minutes caused by the waiting queue, along with the remaining distance, on the display DD.

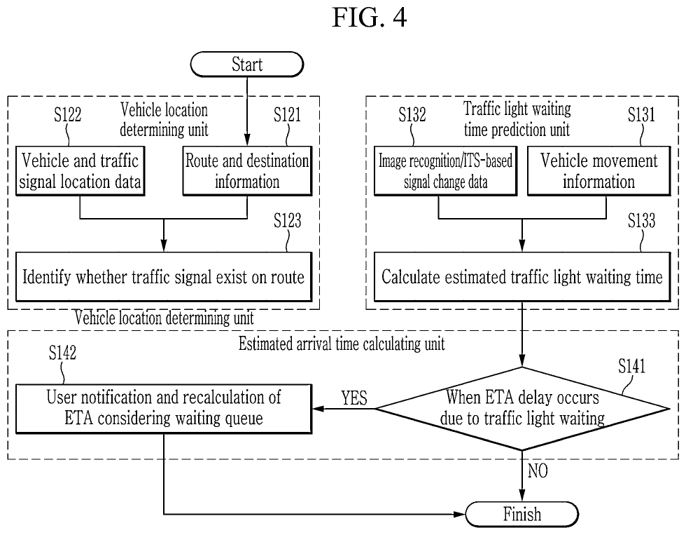

FIG. 4 is a flowchart of a method for calculating an estimated arrival time considering traffic light waiting time, according to an embodiment. The method is described with reference to the apparatus of FIG. 2.

Referring to FIG. 4, at a step or operation S121, the vehicle location determining unit 120 may receive route and destination information from the navigation system.

At a step or operation S122, the vehicle location determining unit 120 may receive vehicle and traffic signal location data from the vehicle location data server 200 and the traffic signal data server 300.

At a step or operation S123, the vehicle location determining unit 120 may identify whether a traffic signal exists on the route by using the received route, destination information, and the vehicle and traffic signal location data.

At a step or operation S131, the traffic light waiting time prediction unit 130 may receive vehicle movement information from the GPS/GNSS 10 and the vehicle location data server 200.

At a step or operation S132, the traffic light waiting time prediction unit 130 may receive image recognition and ITS-based signal change data.

At a step or operation S133, the traffic light waiting time prediction unit 130 may calculate an estimated traffic light waiting time by prediction based on the signal change data and the vehicle movement information.

At a step or operation S141, the estimated arrival time calculating unit 140 may determine whether a delay of the estimated arrival time (ETA) has occurred due to the traffic light waiting by using the estimated traffic light waiting time.

When it is determined that the delay of the ETA has occurred, at a step or operation S142, the estimated arrival time calculating unit 140 may provide an alarm for the occurrence of the delay to the user. The estimated arrival time calculating unit 140 may also recalculate the ETA due to the delay.

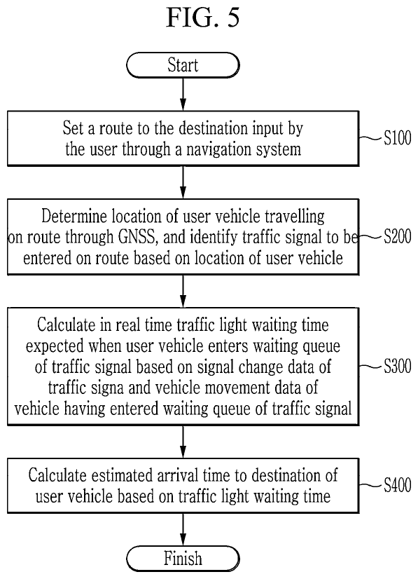

FIG. 5 is a flowchart of a method for calculating the estimated arrival time considering traffic light waiting time, according to an embodiment. The method for calculating estimated arrival time considering the traffic light waiting time may be performed by the apparatus for calculating an estimated arrival time considering traffic light waiting time 100 of FIG. 1.

At a step or operation S100, the apparatus for calculating an estimated arrival time considering traffic light waiting time 100 (hereinafter referred to as the estimated arrival time calculating apparatus) may set a route to the destination input by a user through a navigation system.

At a step or operation S200, the estimated arrival time calculating apparatus 100 may determine a location of the user vehicle travelling on the route using GNSS data. The estimated arrival time calculating apparatus 100 may also identify a traffic signal to be encountered on the route based on the location of the user vehicle.

The estimated arrival time calculating apparatus 100 may determine the location of the user vehicle on a lane-by-lane basis the through precise positioning and map matching based on GNSS. For example, the estimated arrival time calculating apparatus 100 may identify whether the user vehicle has entered or exited a particular lane through precise positioning and map matching based on GNSS.

The estimated arrival time calculating apparatus 100 may identify the traffic signal to be encountered by the user vehicle, from among traffic signals on the route, through image recognition and/or data obtained from a traffic signal data server. For example, the estimated arrival time calculating apparatus 100 may know information on the traffic signal that the vehicle will encounter next, in advance in real time. Information on the traffic signal may include information on the waiting queue of the traffic signal.

At a step or operation S300, the estimated arrival time calculating apparatus 100 may calculate, in real time, the traffic light waiting time expected when the user vehicle enters the waiting queue of the traffic signal based on the signal change data for the traffic signal and vehicle movement data of other vehicles having entered the waiting queue of the traffic signal.

The estimated arrival time calculating apparatus 100 may notify the user of the information on the traffic light waiting time of the traffic signal before entry into the waiting queue of the traffic signal. For example, the estimated arrival time calculating apparatus 100 may notify the user of the traffic light waiting time of the traffic signal before a particular distance or a particular time prior to entering the waiting queue.

The estimated arrival time calculating apparatus 100 may collect the vehicle movement data of vehicles having encountered the traffic signal from a vehicle location data server to which information on the locations of the vehicles on the route is uploaded in real time. The estimated arrival time calculating apparatus 100 may calculate the waiting queue of the traffic signal information based on the vehicle movement data obtained from the vehicle location data server.

The estimated arrival time calculating apparatus 100 may collect the signal change data of the traffic signal from the traffic signal data server. The estimated arrival time calculating apparatus 100 may calculate the traffic light waiting time for the traffic light by using the waiting queue information and the signal change data.

The estimated arrival time calculating apparatus 100 may, when the entry of the user vehicle into the waiting queue of the traffic signal is detected based on the location of the user vehicle, provide notification about the traffic light waiting time calculated in real time to the user.

The estimated arrival time calculating apparatus 100 may detect the entry of the user vehicle into the waiting queue of the traffic signal based on detecting entry of the user vehicle into a particular lane including the waiting queue. When the user vehicle enters the queue lane, by notifying the traffic light waiting time to the user, the estimated arrival time calculating apparatus 100 may prevent the user vehicle from waiting in a different lane.

The estimated arrival time calculating apparatus 100 may predict the traffic light waiting time based on a signal change period of the traffic signal and the average movement distance of the vehicles in the waiting queue during signal change period. For example, when the signal change period of the traffic signal is 3 minutes, in the case that the average movement distance of the vehicles in the waiting queue is about 5 meters for the 3 minutes and a distance remaining until the user vehicle will pass through the traffic signal is about 15 meters, the estimated arrival time calculating apparatus 100 may calculate the traffic light waiting time of about 10 minutes.

At a step or operation S400, the estimated arrival time calculating apparatus 100 may calculate the estimated arrival time to the destination of the user vehicle based on the traffic light waiting time.

The estimated arrival time calculating apparatus 100 may, when the calculated traffic light waiting time is greater than a reference traffic light waiting time by a preset criterion or more, determine that the delay time has occurred in the waiting queue. The estimated arrival time calculating apparatus 100 may then calculate the estimated arrival time to destination by reflecting the delay time.

For example, the estimated arrival time calculating apparatus 100 may preset the preset criterion as 10 minutes. In the case that the reference waiting time of the traffic signal is 5 minutes, when the traffic light waiting time of the traffic signal is calculated as 20 minutes, the estimated arrival time calculating apparatus 100 may determine that a delay time has occurred due to the traffic signal. The estimated arrival time calculating apparatus 100 may update the estimated arrival time by reflecting the delay time in real time.

For example, the estimated arrival time calculating apparatus 100 may update an existing estimated arrival time to the destination by using the calculated estimated arrival time to the destination. The estimated arrival time calculating apparatus 100 may visually and/or audibly provide information on the waiting queue and the delay time occurring in the waiting queue to the user through the navigation system.

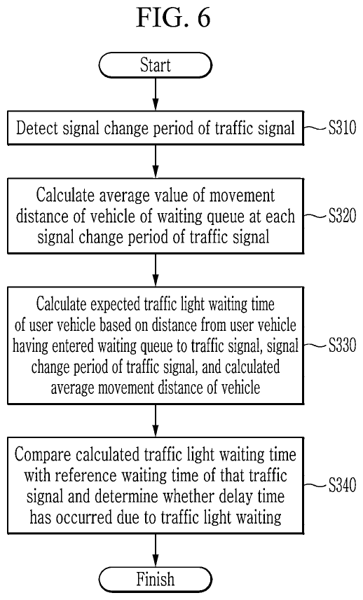

FIG. 6 is a flowchart of a method for calculating an estimated arrival time considering traffic light waiting time, according to an embodiment. FIG. 6 is a flowchart showing a process of calculating in real time the expected traffic light waiting time in FIG. 5.

Referring to FIG. 6, at a step or operation S310, the estimated arrival time calculating apparatus 100 may detect the signal change period of the traffic signal. The estimated arrival time calculating apparatus 100 may detect the signal change period of the traffic signal where the user vehicle will enter based on data obtained from the traffic signal data server 300.

At a step or operation S320, the estimated arrival time calculating apparatus 100 may calculate an average value of moving distances of the vehicles in the waiting queue at each signal change period of the traffic signal. For example, in the case that a period of green light of the traffic signal is 2 minutes, the estimated arrival time calculating apparatus 100 may calculate the average movement distance by which the vehicles in the waiting queue have moved in 2 minutes, for example, as 15 meters.

At a step or operation S330, the estimated arrival time calculating apparatus 100 may calculate the expected traffic light waiting time of the user vehicle based on a distance to the traffic signal from the point at which the user vehicle having entered the waiting queue, the signal change period of the traffic signal, and the calculated average movement distance of the vehicles in the waiting queue.

For example, when 30 meters remains until the user vehicle passes through the traffic signal, since the signal change period is 2 minutes and the average movement distance of the vehicles in the waiting queue for one period is 15 meters, the estimated arrival time calculating apparatus 100 may calculate the traffic light waiting time as 4 minutes.

At a step or operation S340, the estimated arrival time calculating apparatus 100 may compare the calculated traffic light waiting time with a reference traffic light waiting time and determine whether a delay time has occurred due to traffic light waiting.

For example, if the reference waiting time of the traffic signal is 5 minutes, since the calculated traffic light waiting time is 4 minutes, the estimated arrival time calculating apparatus 100 may determine that the delay time due to that traffic signal has not occurred.

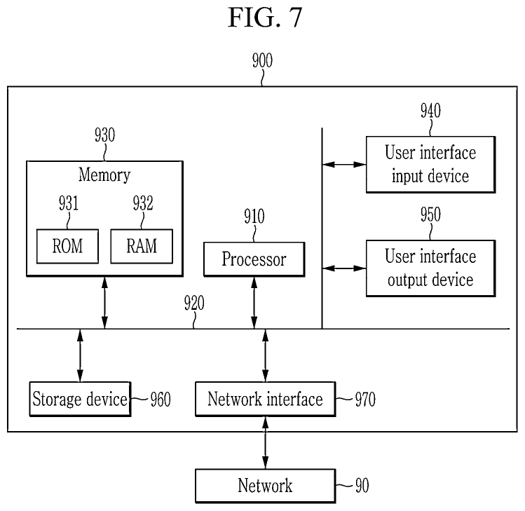

FIG. 7 is a block diagram of a computing device, according to an embodiment.

Referring to FIG. 7, an apparatus and method for calculating an estimated arrival time considering traffic light waiting time according to an embodiment may be implemented by using a computing device 900.

The computing device 900 may include at least one of a processor 910, a memory 930, a user interface input device 940, a user interface output device 950, and a storage device 960 that communicate through a bus 920. The computing device 900 may also include a network interface 970 coupled to a network 90. The network interface 970 may transmit signals to or receive signals from other entities through the network 90.

The processor 910 may be implemented as a micro controller unit (MCU), an application processor (AP), a central processing unit (CPU), a graphic processing unit (GPU), a neural processing unit (NPU), and the like. The processor 910 may be any type of semiconductor device capable of executing instructions stored in the memory 930 or the storage device 960. The processor 910 may be configured to implement the functions, operations and methods described above with respect to FIGS. 1-6.

The memory 930 and the storage device 960 may include various types of volatile or non-volatile storage media. For example, the memory may include read-only memory (ROM) 931 and a random-access memory (RAM) 932. The memory 930 may be located internal or external to the processor 910. The memory 930 may be connected to the processor 910 through various known means.

In some embodiments, at least some configurations, operations, or functions of an apparatus and method for calculating an estimated arrival time considering traffic light waiting time may be implemented as a program or software executable by the computing device 900. The program or software may be stored in a computer-readable medium.

In some embodiments, at least some configurations, operations or functions of an apparatus and method for calculating an estimated arrival time considering traffic light waiting time may be implemented by using hardware or circuitry of the computing device 900 or may also be implemented as separate hardware or circuitry that may be electrically connected to the computing device 900.

While the present disclosure has been described in connection with example embodiments, it should be understood that the disclosure is not limited to the disclosed embodiments. On the contrary, the present disclosure is intended to cover various modifications and equivalent arrangements included within the spirit and scope of the appended claims.

### DESCRIPTION OF SYMBOLS

100: estimated arrival time calculating apparatus
110: route setting unit
120: vehicle location determining unit
130: traffic light waiting time prediction unit
140: estimated arrival time calculating unit
200: vehicle location data server
300: traffic signal data server

What is claimed is:

1. An apparatus for calculating an estimated arrival time considering traffic light waiting time, the apparatus comprising:
a route setting unit configured to set a route for a destination of a user vehicle input by a user through a navigation system;
a vehicle location determining unit configured to
determine a location of the user vehicle on the route by using global navigation satellite system (GNSS) data, and
identify a traffic signal to be encountered by the user vehicle on the route based on the location of the user vehicle;
a traffic light waiting time prediction unit configured to calculate in real time a traffic light waiting time expected after the user vehicle enters a waiting queue of the traffic signal based on signal change data for the traffic signal and vehicle movement data of vehicles in the waiting queue of the traffic signal; and
an estimated arrival time calculating unit configured to calculate an estimated arrival time to the destination of the user vehicle based on the traffic light waiting time.

2. The apparatus of claim 1, wherein the vehicle location determining unit is configured to determine the location of the user vehicle on a lane-by-lane basis through precise positioning and map matching based on the GNSS data.

3. The apparatus of claim 1, wherein the vehicle location determining unit is configured to identify the traffic signal to be encountered by the user vehicle, from among traffic signals on the route, using one or both of image recognition or data obtained from a traffic signal data server.

4. The apparatus of claim 1, wherein the traffic light waiting time prediction unit is configured to collect the vehicle movement data of vehicles having encountered the traffic signal using data obtained from a vehicle location data server to which information on locations of vehicles on the route is uploaded in real time.

5. The apparatus of claim 1, wherein the traffic light waiting time prediction unit is configured to collect the signal change data for the traffic signal from a traffic signal data server.

6. The apparatus of claim 1, wherein the traffic light waiting time prediction unit is configured to, when an entry of the user vehicle into the waiting queue of the traffic signal is detected based on the location of the user vehicle, provide a notification about the traffic light waiting time calculated in real time to the user.

7. The apparatus of claim 6, wherein the traffic light waiting time prediction unit is configured to detect the entry of the user vehicle into the waiting queue of the traffic signal based on determining whether the user vehicle has entered a particular lane designated as the waiting queue.

8. The apparatus of claim 1, wherein the traffic light waiting time prediction unit is configured to predict the traffic light waiting time based on a signal change period of the traffic signal and an average movement distance of the vehicles in the waiting queue during the signal change period.

9. The apparatus of claim 1, wherein the estimated arrival time calculating unit is configured to, when the calculated traffic light waiting time is greater than a reference traffic light waiting time by more than a preset criterion, i) determine that a delay time has occurred in the waiting queue and ii) calculate the estimated arrival time to the destination by reflecting the delay time.

10. The apparatus of claim 9, wherein the estimated arrival time calculating unit is configured to:
update an existing estimated arrival time to the destination by using the calculated estimated arrival time to destination; and
provide information on the waiting queue and the delay time occurring in the waiting queue to the user through the navigation system.

11. A method for calculating an estimated arrival time considering traffic light waiting time, the method comprising:
setting a route for a destination of a user vehicle input by a user through a navigation system;
determining a location of the user vehicle on the route using global navigation satellite system (GNSS) data;
identify a traffic signal to be encountered by the user vehicle on the route based on the location of the user vehicle;
calculating in real time a traffic light waiting time expected when the user vehicle enters a waiting queue of the traffic signal based on signal change data for the traffic signal and vehicle movement data of vehicles having encountered the traffic signal; and
calculating an estimated arrival time to the destination of the user vehicle based on the traffic light waiting time.

12. The method of claim 11, wherein determining the location of the user vehicle includes determining the location of the user vehicle on a lane-by-lane basis through precise positioning and map matching based on the GNSS data.

13. The method of claim 11, wherein identifying the traffic signal includes identifying the traffic signal to be encountered by the user vehicle, from among traffic signals on the route, using one or both of image recognition or data obtained from a traffic signal data server.

14. The method of claim 11, wherein calculating the traffic light waiting time in real time includes collecting the vehicle movement data of vehicles having encountered the traffic signal using data obtained from a vehicle location data server to which information on locations of vehicles on the route is uploaded in real time.

15. The method of claim 11, wherein calculating the traffic light waiting time in real time includes collecting the signal change data for the traffic signal from a traffic signal data server.

16. The method of claim 11, further comprising providing a notification about the traffic light waiting time calculated in real time to the user when an entry of the user vehicle into the waiting queue of the traffic signal is detected based on the location of the user vehicle.

17. The method of claim 16, further comprising detecting the entry of the user vehicle into the waiting queue of the traffic signal based on detecting an entry of the user vehicle into a particular lane including the waiting queue.

18. The method of claim 11, wherein calculating the traffic light waiting time in real time includes predicting the traffic light waiting time based on a signal change period of the traffic signal and an average movement distance of the vehicles in the waiting queue during the signal change period.

19. The method of claim 11, wherein calculating the estimated arrival time to the destination of the user vehicle includes:
determining, when the calculated traffic light waiting time is greater than a reference traffic light waiting time by a preset criterion or more, that a delay time has occurred in the waiting queue; and
calculating the estimated arrival time to destination by reflecting the delay time.

20. The method of claim 19, wherein:
calculating the estimated arrival time to the destination of the user vehicle further includes updating an existing estimated arrival time to the destination by using the calculated estimated arrival time to the destination; and
the method further comprises visually and/or audibly providing information on the waiting queue and the delay time occurring in the waiting queue to the user through the navigation system.
